(19) United States
(12) Patent Application Publication
(10) Pub. No.: US 2021/0365838 A1
(43) Pub. Date: Nov. 25, 2021

(54) APPARATUS AND METHOD FOR MACHINE LEARNING BASED ON MONOTONICALLY INCREASING QUANTIZATION RESOLUTION

(71) Applicant: ELECTRONICS AND TELECOMMUNICATIONS RESEARCH INSTITUTE, Daejeon (KR)

(72) Inventors: Jin-Wuk SEOK, Daejeon (KR); Jeong-Si KIM, Daejeon (KR)

(21) Appl. No.: 17/326,238

(22) Filed: May 20, 2021

(30) Foreign Application Priority Data
May 22, 2020 (KR) 10-2020-0061677
May 4, 2021 (KR) 10-2021-0057783

(51) Int. Cl. G06N 20/00

(52) U.S. Cl. CPC G06N 20/00

(57) ABSTRACT

Disclosed herein are an apparatus and method for machine learning based on monotonically increasing quantization resolution. The method, in which a quantization coefficient is defined as a monotonically increasing function of time, includes initially setting the monotonically increasing function of time, performing machine learning based on a quantized learning equation using the quantization coefficient defined by the monotonically increasing function of time, determining whether the quantization coefficient satisfies a predetermined condition after increasing the time, newly setting the monotonically increasing function of time when the quantization coefficient satisfies the predetermined condition, and updating the quantization coefficient using the newly set monotonically increasing function of time. Here, performing the machine learning, determining whether the quantization coefficient satisfies the predetermined condition, newly setting the monotonically increasing function of time, and updating the quantization coefficient may be repeatedly performed.

### CROSS REFERENCE TO RELATED APPLICATIONS

This application claims the benefit of Korean Patent Application No. 10-2020-0061677, filed May 22, 2020, and No. 10-2021-0057783, filed May 4, 2021, which are hereby incorporated by reference in their entireties into this application.

### BACKGROUND OF THE INVENTION

### 1. Technical Field

The present invention relates to machine learning and signal processing.

### 2. Description of the Related Art

Quantization technology is one of technologies that have been researched in a signal-processing field for a long time, and with regard to machine learning, research for implementing large-scale machine-learning networks or for compressing machine-learning results to make the same more lightweight has been carried out.

Particularly these days, research for adopting quantization in learning itself and using the same for implementation of embedded systems or dedicated neural-network hardware is underway. Quantized learning yields satisfactory results in some fields, such as image recognition and the like, but quantization is generally known not to exhibit good optimization performance due to the presence of quantization errors.

### SUMMARY OF THE INVENTION

An object of an embodiment is to minimize quantization errors and implement an optimization algorithm having good performance in lightweight hardware in machine-learning and nonlinear-signal-processing fields in which quantization is used.

A machine-learning method based on monotonically increasing quantization resolution, in which a quantization coefficient is defined as a monotonically increasing function of time, according to an embodiment may include initially setting the monotonically increasing function of time, performing machine learning based on a quantized learning equation using the quantization coefficient defined by the monotonically increasing function of time, determining whether the quantization coefficient satisfies a predetermined condition after increasing the time, newly setting the monotonically increasing function of time when the quantization coefficient satisfies the predetermined condition, and updating the quantization coefficient based on the newly set monotonically increasing function of time. Here, performing the machine learning, determining whether the quantization coefficient satisfies the predetermined condition, newly setting the monotonically increasing function of time, and updating the quantization coefficient may be repeatedly performed.

Here, the quantization coefficient may be defined as a function varying over time as shown in Equation (32) below:

$$σ ( t ) = \frac{γ}{24} \cdot {Q}_{p}^{- 2} ( t ) , γ ∈ R \qquad ( 32 )$$

Here, Q may be defined as shown in Equation (33) below:

Qₚ=η·bⁿ η∈Z⁺,η<b (33)

where a base b is b∈Z⁺, b≥2.

Here, the quantized learning equation may be a learning equation for acquiring quantized weight vectors for all times, as defined in Equation (34) below:

$$\begin{matrix}{w}_{t + 1}^{Q} = {w}_{t}^{Q} - \frac{{α}_{t}}{{Q}_{p}^{2}} \cdot {Q}_{p} ∇ f ( {w}_{t} ) + {\vec{ɛ}}_{t} {Q}_{p}^{- 1} \\ = {w}_{t}^{Q} - \frac{{α}_{t}}{{Q}_{p}} \cdot \frac{1}{{Q}_{p}} [ {Q}_{p} ∇ f ( {w}_{t} ) ] ∵ {α}_{t} ∈ Q ( 0 , {Q}_{p} ) \\ = {w}_{t}^{Q} - \frac{{α}_{t}}{{Q}_{p}} ∇ {f}^{Q} ( {w}_{t} )\end{matrix} \qquad ( 34 )$$

Here, the quantized learning equation may be a learning equation based on a binary number system, as defined in Equation (35) below:

wₜ₊₁^{Q}=wₜ^{Q}−2^{-(n-k)}∇ƒ^{Q}(wₜ), n,k∈Z⁺, n>k (35)

Here, the quantized learning equation may be a probability differential learning equation defined in Equation (36) below:

dWₛ=−λₜ∇ƒ(Wₛ)ds+\sqrt{2σ(s)}·d\vec{B}ₛ (36)

Here, the quantization coefficient may be defined using h̅(t), which is a monotonically increasing function of time, as shown in Equation (37) below:

Qₚ=η·b^{h̅(t)}, such that h̅(t)↑∞ as t→∞ (37)

Here, initially setting the monotonically increasing function of time may be configured to set the monotonically increasing function so as to satisfy Equation (38) below:

$$\frac{C}{ln 2} \leq σ ( t ) {\vert}_{t = 0} = \frac{γ}{24} \cdot {( η \cdot {b}^{\overline{h} ( 0 )} )}^{- 1} \leq \frac{{C}_{1}}{ln 2} = T ( t ) ⟹ {log}_{b} \frac{γln2}{24 η} {C}_{1}^{- 1} \leq \overline{h} ( 0 ) \leq {log}_{b} \frac{γln2}{24 η} {C}^{- 1} \qquad ( 38 )$$

Here, when determining whether the quantization coefficient satisfies the predetermined condition is performed, the predetermined condition may be Equation (39) below:

$$σ ( t ) \geq \frac{C}{log ( t + 2 )} \qquad ( 39 )$$

Here, when newly setting the monotonically increasing function of time is performed, the monotonically increasing function of time may be defined as Equation (40) below:

$$\overline{h} ( {t}_{1} ) = ⌊ {log}_{b} \frac{γln2}{24 η} {C}^{- 1} + 0.5 ⌋ \qquad ( 40 )$$

A machine-learning apparatus based on monotonically increasing quantization resolution according to an embodiment may include memory in which at least one program is recorded and a processor for executing the program. A quantization coefficient may be defined as a monotonically increasing function of time, and the program may perform initially setting the monotonically increasing function of time, performing machine learning based on a quantized learning equation using the quantization coefficient defined by the monotonically increasing function of time, determining whether the quantization coefficient satisfies a predetermined condition after increasing the time, newly setting the monotonically increasing function of time when the quantization coefficient satisfies the predetermined condition, and updating the quantization coefficient based on the newly set monotonically increasing function of time. Here, performing the machine learning, determining whether the quantization coefficient satisfies the predetermined condition, newly setting the monotonically increasing function of time, and updating the quantization coefficient may be repeatedly performed.

### BRIEF DESCRIPTION OF THE DRAWINGS

The above and other objects, features, and advantages of the present invention will be more clearly understood from the following detailed description taken in conjunction with the accompanying drawings, in which:

FIG. 1 and FIG. 2 are views for explaining a method for machine learning having monotonically increasing quantization resolution;

FIG. 3 is a flowchart for explaining a machine-learning method based on monotonically increasing quantization resolution according to an embodiment;

FIG. 4 is a hardware concept diagram according to an embodiment; and

FIG. 5 is a view illustrating a computer system configuration according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

As is generally known, when quantization resolution is sufficiently high and well defined, quantization errors can be considered to be white noise. Accordingly, if quantization errors can be defined as white noise or an independent and identically distributed (i.i.d.) process, the variance of the quantization errors may be made to monotonically decrease over time by setting the quantization errors to monotonically decrease over time.

When quantization resolution is given as a monotonically increasing function of time, quantization errors become a monotonically decreasing function of time, so a global optimization algorithm for a non-convex objective function can be implemented, and this is the same dynamics as a stochastic global optimization algorithm. Also, because of the use of quantization, a machine-learning algorithm that enables global optimization may be implemented even in systems having low computing power, such as embedded systems.

Accordingly, in an embodiment, global optimization is achieved in such a way that, when quantization to integers or fixed-point numbers, applied to an optimization algorithm, is performed, quantization resolution monotonically increases over time.

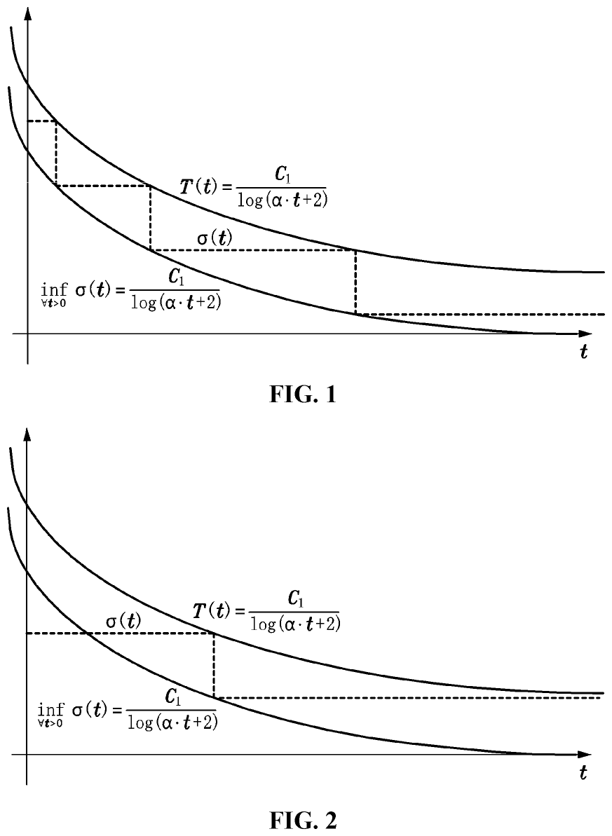

Hereinafter, a machine-learning apparatus and method having monotonically increasing quantization resolution according to an embodiment will be described in detail with reference to FIGS. 1 to 5.

In the machine-learning apparatus and method having monotonically increasing quantization resolution according to an embodiment, first, Definitions 1 to 3 below are required.

### Definition 1

The objective function to be optimized may be defined as follows.

For a weight vector wₜ∈Rⁿ and a data vector xₖ∈Rⁿ in an epoch unit t, the objective function ƒ: Rⁿ→R is as shown in Equation (1) below:

$$f ( {w}_{t} ) ≡ \frac{1}{N} {\sum }_{k = 1}^{N} \overline{f} ( {w}_{t} , {x}_{k} ) = \frac{1}{N} {\sum }_{l = 1}^{L} {\sum }_{k = 1}^{{B}_{t}} \overline{f} ( {w}_{t} , {x}_{k} ) \qquad ( 1 )$$

In Equation (1), ƒ: Rⁿ×R→R denotes a loss function for the weight vector and the data vector, N denotes the number of all data vectors, L denotes the number of mini-batches, and Bₗ denotes the number of pieces of data included in the l-th mini-batch.

### Definition 2

For an arbitrary vector x∈R, truncation of a fractional part is defined as shown in Equation (2) below:

x^{Q}≡└x┘+ϵ(ϵ∈R[0,1)) (2)

In Equation (2), x^{Q}∈Z is the whole part of the real number x.

### Definition 3

The greatest integer function or the Gauss's bracket [⋅] is defined as shown in Equation (3) below:

[x]≡└x+0.5┘=x+0.5 −ϵ [symbol] x+ϵ (3)

where ϵ∈R(−0.5,0.5] is a round-off error.

In an embodiment, the objective function satisfies the following assumption for convergence and feature analysis. Particularly, the following assumption is definitely satisfied when an activation function, having maximum and minimum limits and based on Boltzmann statistics or Fermion statistics, is used in machine learning.

Assumption 1

For an arbitrary vector x satisfying x∈Rⁿ, x∈B^{o}(x*,ρ), positive numbers (0<m<M<∞) satisfying the following equation are present for the objective function ƒ: Rⁿ→R in which ƒ(x)∈C².

$$m {‖ v ‖}^{2} \leq 〈 v , \frac{{\partial }^{2} f}{\partial {x}^{2}} ( x ) v 〉 \leq M {‖ v ‖}^{2} \qquad ( 4 )$$

In Equation (4), B^{o}(x,ρ) is an open set that satisfies the following equation for a positive number ρ∈R, ρ>0.

B^{o}(x*,ρ)={x|∥x−x*∥<ρ}. (5)

Based on the definitions and assumptions described above, a machine-learning apparatus and method having monotonically increasing quantization resolution according to an embodiment will be described in detail.

In most existing studies on machine learning, quantization is defined in the form of multiplying a sign function of a variable x by a quantization function based on appropriate conditions for a quantization coefficient Qₚ (Qₚ∈Q,Qₚ>0), as shown in Equation (6) below:

$${x}^{Q} = \{ \begin{matrix}0 & C ( x , QP ) < {δ}_{1} \\ sign ( x ) & {δ}_{1} \leq C ( x , QP ) < {δ}_{2} \\ g ( x , {Q}_{p} ) sign ( x ) & Otherwise\end{matrix} \qquad ( 6 )$$

In existing studies, researchers have proposed definitions and applications of various forms of quantization coefficients in order to improve the performance of their quantization techniques. Most such quantization techniques are oriented toward increasing the accuracy of a quantization operation by decreasing quantization errors. That is, a quantization step value varies depending on the position of x, as shown in Equation (6), whereby quantization resolution is changed in the spatial terms, and this methodology generally exhibits good performance.

If defining quantization errors to be different in the spatial terms is capable of yielding a satisfactory result, as shown in the existing studies, defining quantization errors differently in terms of time may also yield a satisfactory result, and the present invention is based on this idea.

To this end, it is necessary to define more basic quantization than Equation (6), although derived from Equation (6). Accordingly, in an embodiment, a basic form of quantization may be defined using the above-described Definition 2 and Definition 3, as shown in Equation (7) below:

$${x}^{Q} {=}^{Δ} \frac{1}{{Q}_{p}} ⌊ {Q}_{p} \cdot ( x + 0.5 \cdot {Q}_{p}^{- 1} ) ⌋ = \frac{1}{{Q}_{p}} [ {Q}_{p} \cdot x ] ∈ Q \qquad ( 7 )$$

Based on Equation (7), an equation for the quantization error may be defined as shown in Equation (8) below:

$${x}^{Q} = \frac{1}{{Q}_{p}} ⌊ {Q}_{p} \cdot ( x + 0.5 \cdot {Q}_{p}^{- 1} ) ⌋ = \frac{1}{{Q}_{p}} ( {Q}_{p} \cdot x + ɛ ) = x + {ɛQ}_{p}^{- 1} \qquad ( 8 )$$

According to an embodiment, when the fixed quantization step Qₚ in Equation (8) is given as a function increasing with time, a quantization error that monotonically decreases over time is simply acquired.

Also, it has been proved that if quantization errors are asymptotically pairwise independent and have uniform distribution in a quantization error range, the quantization errors are white noise.

It is intuitively obvious that in order for quantization errors to have uniform distribution, quantization must be uniform quantization. Accordingly, an embodiment assumes only uniform quantization having identical resolution at the same t, without changing the quantization resolution in the spatial terms.

Also, because a binary number system is generally used in engineering, the quantization parameter Qₚ is defined as shown in Equation (9) below in order to support the binary number system.

Qₚ=η·bⁿ η∈Z⁺, η<b (9)

where the base b is b∈Z⁺, b≥2.

Based on the above-described assumption, if quantization of x is uniform quantization according to the quantization parameter defined by Equations (7) and (9) in the present invention, the quantization error ϵQₚ(t)=x^{Q}−x is regarded as white noise.

In order to apply this to general machine-learning, it is assumed that white noise described by Equation (10) is defined for an n-dimensional weight vector wₜ∈Rⁿ.

\vec{ϵ}Qₚ=x^{Q}−x={ϵ₀,ϵ₁, . . . ϵₙ₋₁}∈Rⁿ (10)

Based on the above-described Definition 1, a general gradient-based learning equation may be as shown in Equation (11) below:

wₜ₊₁=wₜ−λₜ∇ƒ(wₜ) (11)

In Equation (11), λₜ∈R(0,1) is a learning rate, and satisfies λₜ=argmin_{λ}_{ₜ}_{inR(0,1)}ƒ(wₜ−λₜ∇ƒ(wₜ)), and wₜ is a weight vector that satisfies wₜ∈Rⁿ.

Here, when the weight vectors wₜ and wₜ₊₁ are assumed to be quantized, the learning equation in Equation (11) may be updated as shown in Equation (12) below:

wₜ₊₁^{Q}=(wₜ^{Q}−λₜ∇ƒ(wₜ))^{Q}=wₜ^{Q}−(λₜ∇ƒ(wₜ))^{Q}. (12)

When g(x,t)≡λₜ∇ƒ(x) is substituted into Equation (12) and when this is quantized based on Equation (7), Equation (13) may be derived.

$${g ( x )}^{Q} = \frac{1}{{Q}_{p}} ⌊ {Q}_{p} ( g ( x ) + 0.5 {Q}_{p}^{- 1} ) ⌋ = \frac{1}{{Q}_{p}} \cdot {Q}_{p} g ( x ) + {\vec{ɛ}}_{t} {Q}_{p}^{- 1} \qquad ( 13 )$$

In Equation (13), \vec{ϵ}ₜ is a quantization error having a vector value that is defined as \vec{ϵ}ₜ∈Rⁿ, in which case the respective components thereof have errors defined in Definition 3 and the probability distributions of the components are independent.

If λₜ=aₜQ⁻¹ is satisfied because a rational number aₜ∈Q(0,Qₚ) is present, g(x) is factorized to g(x)=aₜQₚ⁻¹h(x), which may be represented as shown in Equation (14) below:

$${g ( x )}^{Q} = \frac{{α}_{t}}{{Q}_{p}^{2}} \cdot {Q}_{p} h ( x ) + {\vec{ɛ}}_{t} {Q}_{p}^{- 1} . \qquad ( 14 )$$

When Equation (14) is substituted into Equation (12) after h(x) in Equation (14) is changed to ∇ƒ(wₜ), the following quantized learning equation shown in Equation (15) may be acquired:

$$\begin{matrix}{w}_{t + 1}^{Q} = {w}_{t}^{Q} - \frac{{α}_{t}}{{Q}_{p}^{2}} \cdot {Q}_{p} ∇ f ( {w}_{t} ) + {\vec{ɛ}}_{t} {Q}_{p}^{- 1} \\ {w}_{t}^{Q} - \frac{{α}_{t}}{{Q}_{p}} \cdot \frac{1}{{Q}_{p}} [ {Q}_{p} ∇ f ( {w}_{t} ) ] ∵ {α}_{t} ∈ Q ( 0 , {Q}_{p} ) \\ {w}_{t}^{Q} - \frac{{α}_{t}}{{Q}_{p}} ∇ {f}^{Q} ( {w}_{t} )\end{matrix} \qquad ( 15 )$$

Consequently, Equation (15), which is a learning equation for acquiring quantized weight vectors for all steps t, is acquired through mathematical induction in an embodiment.

In consideration of general hardware based on binary numbers, b and are set to b=2, η=1 in Equation (9), so αₜ=2^{k}, k<n. Accordingly, Qₚ=2ⁿ is satisfied, and a quantized learning equation is simplified as shown in Equation (16) below:

wₜ₊₁^{Q}=wₜ^{Q}−2^{-(n-k)}∇ƒ^{Q}(wₜ), n,k∈Z⁺, n>k (16)

Equation (16) shows that a learning equation in machine learning can be simplified through a right shift operation performed on the quantized ∇^{Q}ƒ(wₜ).

As appears in Equation (16), the most extreme form of quantization is defined by k=n−1, and the quantized gradient becomes a single bit of a sign vector. Here, when ∥δ₂−δ₁∥=Qₚ and

$$‖ {δ}_{1} ‖ = \frac{{Q}_{p}}{2} ,$$

Equation (6) may be regarded as a quantization system that is uniformly quantized to Qₚ.

An embodiment is a quantization method configured to change Qₚ over time, rather than spatial quantization.

Assuming that each component of \vec{ϵ}ₜ∈Rⁿ in Equation (14) is defined like the round-off error of Definition 3 and that quantization errors are uniformly distributed, the variance of the quantization errors may be as shown in Equation (17) below:

$$∀ {ɛ}_{t} ∈ R , {𝔼ɛ}_{t}^{2} {Q}_{p}^{- 2} = \frac{1}{12 \cdot {Q}_{p}^{ {2}^{′}}} , ∀ {\vec{ɛ}}_{t} ∈ {R}^{n} , 𝔼 {Q}_{p}^{- 2} {\vec{ɛ}}_{t}^{2} = 𝔼 {Q}_{p}^{- 2} \cdot tr ( {\vec{ɛ}}_{t} {\vec{ɛ}}_{t}^{T} ) = \frac{1}{12 \cdot {Q}_{p}^{ 2}} \cdot n \qquad ( 17 )$$

When the variance of the quantization errors at an arbitrary time (t>0) is as shown in Equation (17), if ϵₜQₚ⁻¹ds=q·dBₜ is given for a standard one-dimensional Wiener process dBₜ∈R, Equation (18) may be derived.

$${𝔼ɛ}_{t}^{2} {Q}_{p}^{- 2} ds = 𝔼 {q}^{2} {dB}_{t}^{2} = {q}^{2} ds ⇒ \frac{1}{12} {Q}_{p}^{- 2} = {q}^{2} ⇒ q = \sqrt{\frac{1}{12}} \cdot {Q}_{p}^{- 1} \qquad ( 18 )$$

In the same manner, when d\vec{B}ₜ=\vec{ϵ}ds∈Rⁿ is given as a vector-form Wiener process and when \vec{ϵ}ₜQₚ⁻¹ds=q·d\vec{B}ₜ, is assumed, q=\sqrt{n/12}·Qₚ⁻¹ is acquired.

Here, if the variance of the quantization errors in Equation (18) is a function of time, because only the quantization coefficient Qₚ is a parameter varying over time, Qₚ is taken as a function of time, and Equation (19) is defined.

$$σ ( t ) = \frac{γ}{24} \cdot {Q}_{p}^{- 2} ( t ) , γ ∈ R \qquad ( 19 )$$

Therefore, when the learning equation is given as shown in Equation (11), if the quantized weight vector wₜ^{Q}∈Rⁿ is regarded as a probability process {Wₜ}ₜ₌₀^{∞}, Equation (15), which is the learning equation, may be defined in the form of the probability differential equation shown in Equation (20) below:

$$\begin{matrix}\begin{matrix}{dW}_{\text{?}} = - {λ}_{t} ∇ f ( {W}_{s} ) ds + {\vec{ɛ}}_{\text{?}} {Q}_{p}^{- 1} ( s ) ds \\ = - {λ}_{t} ∇ f ( {W}_{s} ) ds + \sqrt{\frac{n}{12}} {Q}_{p}^{- 1} ( s ) d \vec{{B}_{s}}\end{matrix} & ( 20 )\end{matrix} \text{?} \text{indicates text missing or illegible when filed}$$

When γ=n in Equation (20), a simplified equation may be derived, as shown in Equation (21) below:

dWₜ=−λₜ∇ƒ(Wₛ)ds+\sqrt{2σ(s)}·d\vec{B}ₛ (21)

With regard to Equation (21), the transition probability of a weight vector is known as weakly converging to Gibb's probability, as shown in Equation (22), under appropriate conditions.

$${\text{?}}_{σ ( t )} ( {W}_{t} ) = \frac{1}{{Z}_{σ ( t )}} exp ( - \frac{f ( {W}_{t} )}{σ ( t )} ) , where {Z}_{σ ( t )} = {\int }_{{R}^{n}} exp ( - \frac{f ( {W}_{s} )}{σ ( s )} ) ds \\ \text{?} \text{indicates text missing or illegible when filed} \qquad ( 22 )$$

Here, it is known that, when σ(t)→0, the transition probability of the weight vector converges to the global minima of ƒ(Wₜ).

This means that the limit of Equation (19) is as shown in Equation (23) below:

$${lim σ}_{t ↑ ∞} ( t ) = \frac{γ}{24} \cdot {lim σ}_{t ↑ ∞} {Q}_{p}^{- 2} ( t ) = 0 \qquad ( 23 )$$

That is, whenever t monotonically increases, the magnitude of the quantization coefficient monotonically increases (i.e., Qₚ(t)↑∞) in response thereto, which means that the quantization resolution increases over time. That is, according to the present invention, after quantization resolution is set to be low at the outset (that is, a Qₚ value is small), the quantization coefficient Qₚ is increased according to a suitable time schedule, and when the quantization resolution becomes high, global minima may be found.

Here, a quantization coefficient determination method through which the global minima can be found will be additionally described below.

When Equation (21) and Equation (23) are satisfied, if σ(t) satisfying the condition of Equation (24) is given, global minima may be found by simulated annealing.

$${inf σ ( t )}_{t} = \frac{C}{log ( t + 2 )} , C ∈ R , C >> 0 \qquad ( 24 )$$

However, because σ(t) is a value that is proportional to the integer value Qₚ(t), it is difficult to directly substitute a continuous function, as in Equation (24).

Other conditions are T(t)≥c/log(2+t), “T(t)↓0”, and “T(t) is continuously differentiable” while satisfying Equation (25).

$$\begin{matrix}\frac{d}{dt} {e}^{- \frac{2 Δ}{T ( t )}} = \frac{d T ( t )}{dt} \cdot \frac{1}{{T}^{2} ( t )} {e}^{- \frac{2 Δ}{T ( t )}} \to 0 & ∵ Δ = {sup}_{x , y ∈ {R}^{n}} ( f ( x ) - f ( y ) )\end{matrix} \qquad ( 25 )$$

Accordingly, when T(t) is set as the upper limit of σ(t) and when

$$\frac{C}{log ( t + 2 )}$$

is set as the lower limit of σ(t), σ(t) may be selected such that the characteristics of the upper-limit schedule T(t) is satisfied.

FIG. 1 and FIG. 2 illustrate the graphs of T(t) and σ(t) as a function of time t.

Referring to FIG. 1, T(t) and σ(t) may be defined by the relationship shown in Equation (26) below:

$$\frac{C}{log ( t + 2 )} \leq σ ( t ) \leq T ( t ) \qquad ( 26 )$$

In Equation (26), when a positive number a E. R is present and satisfies a<1, if T(t) is defined as T(t)=C₁/log(a·t+2) for C₁>C, T(t)≥C/log(t+2) is always satisfied. Accordingly, when σ(t) is set to satisfy Equations (9) and (19), which are conditions for quantization, while satisfying Equation (26), σ(t) satisfies Equation (25) although it is not continuously differentiable, whereby global minima can be found.

The quantization coefficient Qₚ(t) may be defined as shown in Equation (27) below using h̅(t)∈Z⁺, which is a monotonically increasing function of time.

Qₚ(t)=η·b^{h̅(t)}, such that h̅(t)↑∞ as t→∞ (27)

A machine-learning method based on monotonically increasing quantization resolution through which global minima can be found based on Equation (19), Equation (26), and Equation (27) will be described below.

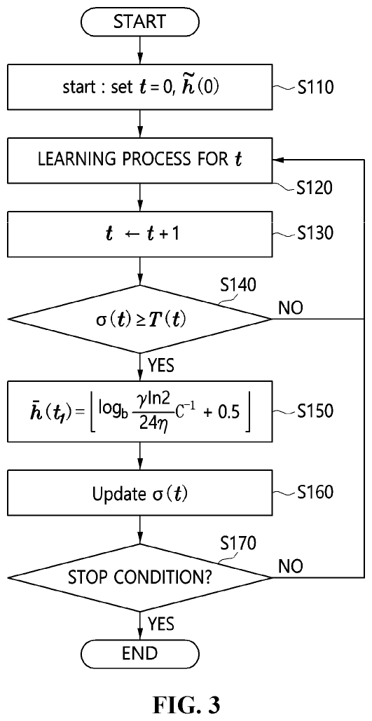

FIG. 3 is a flowchart for explaining a machine-learning method based on monotonically increasing quantization resolution according to an embodiment.

Here, it is assumed that a quantization coefficient is given as shown in Equation (27) and that σ(t) satisfies Equation (19).

First, a monotonically increasing function of time is initially set at step S110. That is, as shown in FIG. 1, when t=0, h̅(0) satisfying the following is set.

$$\frac{C}{ln 2} \leq σ ( t ) {\vert}_{t = 0} = \frac{γ}{24} \cdot {( η \cdot {b}^{\overline{h} ( 0 )} )}^{- 1} \leq \frac{{C}_{1}}{ln 2} = T ( t ) ⇒ {log}_{b} \frac{γln 2}{24 η} {C}_{1}^{- 1} \leq \overline{h} ( 0 ) \leq {log}_{b} \frac{γln 2}{24 η} {C}^{- 1} \qquad ( 28 )$$

If the number of bits suitable for an initial value is not found using Equation (28), a suitable h̅(0) is set, as shown in FIG. 2.

Then, machine learning is performed at step S120 based on a quantized learning equation using the quantization coefficient defined by the monotonically increasing function of time t.

Then, time is increased from t to t+1 at step S130, and whether the quantization coefficient satisfies a predetermined condition σ(t)≥T(t) is determined at step S140.

When it is determined at step S140 that the quantization coefficient does not satisfy the predetermined condition σ(t)≥T(t), that is, when σ(t)<T(t) is satisfied under the condition of t>0, the quantization coefficient is not updated, and σ(t) is set to

$$σ ( t ) = \frac{γ}{24} {( η \cdot {b}^{\overline{h ( 0 )}} )}^{- 1} .$$

Then, machine learning is performed at step S120 based on the quantized learning equation using the quantization coefficient defined by the monotonically increasing function of time t.

Conversely, when it is determined at step S140 that the quantization coefficient satisfies the predetermined condition σ(t)≥T(t), the monotonically increasing function of time is newly set at step S150.

That is, if the first t satisfying σ(t)≥T(t) is t₁, h̅(t₁)∈Z⁺ satisfying

$$σ ( t ) \geq \frac{c}{log ( t + 2 )}$$

may be defined as shown in Equation (29) below:

$$\overline{h} ( t + 1 ) = ⌊ {log}_{b} \frac{γ ln 2}{24 η} {C}^{- 1} + 0.5 ⌋ \qquad ( 29 )$$

Then, the quantization coefficient is updated by the newly set monotonically increasing function of time at step S160.

Then, machine learning is performed at step S120 based on the quantized learning equation using the quantization coefficient defined by the monotonically increasing function of the time t.

Steps S120 to S160 may be repeated until a learning stop condition is satisfied at step S170.

Referring to FIG. 3, the time coefficient t may actually correspond to a single piece of data. However, when there is a large amount of data, scheduling may be performed by adjusting the time coefficient depending on the number of pieces of data.

For example, assuming that the number of all pieces of data is N, that there are L mini-batches, and that the respective mini-batches are assigned the same number of pieces of data, the time coefficient is updated by 1 each time N/L pieces of data are processed.

Here, when the time coefficient updated for each mini-batch is t′, the time coefficient may be defined as shown in Equation (30) below:

$${t}^{′} = \frac{N}{L} \cdot t \qquad ( 30 )$$

Meanwhile, when this is actually implemented in hardware, η=1, b=2 are satisfied in Equation (9) due to the characteristics of binary systems. Accordingly, Equation (29) for calculating variation in the quantization coefficient value over time may be simplified as shown in Equation (31) below:

$$\overline{h} ( t ) = ⌊ {log}_{2} \frac{n ln 2}{24} {C}^{- 1} + 0.5 ⌋ \qquad ( 31 )$$

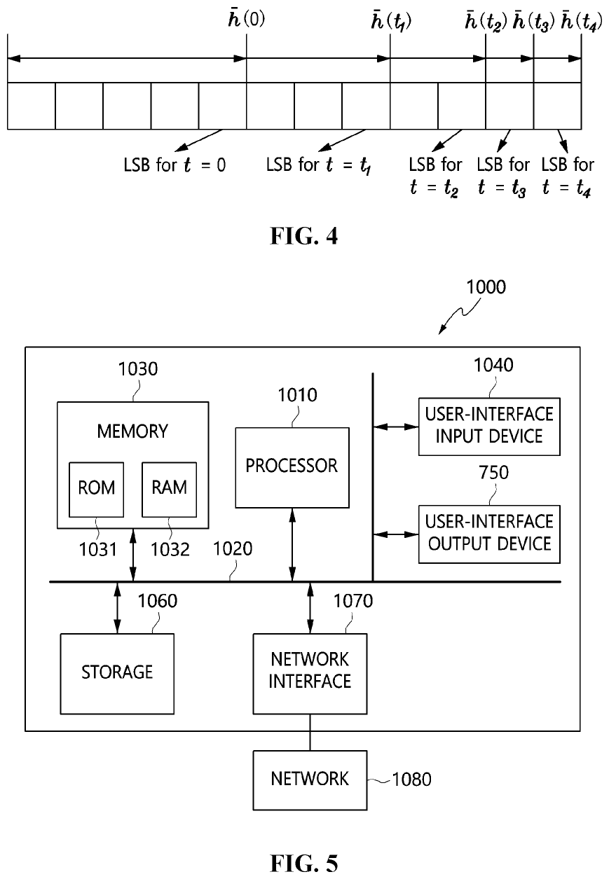

FIG. 4 is a hardware concept diagram according to an embodiment.

That is, FIG. 4 illustrates the structure of the data storage device of a computing device for machine learning for supporting varying quantization resolution in order to implement the above-described machine-learning algorithm based on a quantization coefficient varying over time in hardware.

FIG. 5 is a view illustrating a computer system configuration according to an embodiment.

The machine-learning apparatus based on monotonically increasing quantization resolution according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, and an information delivery medium. For example, the memory 1030 may include ROM 1031 or RAM 1032.

According to an embodiment, quantization is performed while quantization resolution is varied over time, unlike in existing machine-learning algorithms based on quantization, whereby better machine-learning and nonlinear optimization performance may be achieved.

According to an embodiment, because a methodology or a hardware design methodology based on which global optimization can be performed using integer or fixed-point operations is applied to machine learning and nonlinear optimization, optimization performance better than that of existing algorithms may be achieved, and excellent learning and optimization performance may be achieved in existing large-scale machine-learning frameworks, fields in which low power consumption is required, or embedded hardware configured with multiple large-scale RISC modules.

According to an embodiment, because there is no need for a floating-point operation module, which requires a relatively long computation time, the present invention may be easily applied in the fields in which real-time processing is required for machine learning, nonlinear optimization, and the like.

What is claimed is:

1. A machine-learning method based on monotonically increasing quantization resolution, in which a quantization coefficient is defined as a monotonically increasing function of time, comprising:
initially setting the monotonically increasing function of time;
performing machine learning based on a quantized learning equation using the quantization coefficient defined by the monotonically increasing function of time;
determining whether the quantization coefficient satisfies a predetermined condition after increasing the time;
newly setting the monotonically increasing function of time when the quantization coefficient satisfies the predetermined condition; and
updating the quantization coefficient based on the newly set monotonically increasing function of time,
wherein performing the machine learning, determining whether the quantization coefficient satisfies the predetermined condition, newly setting the monotonically increasing function of time, and updating the quantization coefficient are repeatedly performed.

2. The machine-learning method of claim 1, wherein the quantization coefficient is defined as a function varying over time as shown in Equation (32) below:
$$σ ( t ) = \frac{γ}{24} \cdot {Q}_{p}^{- 2} ( t ) , γ ∈ R \qquad ( 32 )$$

3. The machine-learning method of claim 2, wherein Q is defined as shown in Equation (33) below:
Qₚ=η·bⁿ η∈Z⁺,η<b (33)
where a base b is b∈Z⁺, b≥2.

4. The machine-learning method of claim 2, wherein the quantized learning equation is a learning equation for acquiring quantized weight vectors for all times, as defined in Equation (34) below:
$$\begin{matrix}{w}_{t + 1}^{Q} = {w}_{t}^{Q} - \frac{{α}_{t}}{{Q}_{p}^{2}} \cdot {Q}_{p} ∇ f ( {w}_{t} ) + {\vec{ɛ}}_{t} {Q}_{p}^{- 1} \\ = {w}_{t}^{Q} - \frac{{α}_{t}}{{Q}_{p}} \cdot \frac{1}{{Q}_{p}} [ {Q}_{p} ∇ f ( {w}_{t} ) ] ∵ {α}_{t} ∈ Q ( 0 , {Q}_{p} ) \\ = {w}_{t}^{Q} - \frac{{α}_{t}}{{Q}_{p}} ∇ {f}^{Q} ( {w}_{t} )\end{matrix} \qquad ( 34 )$$

5. The machine-learning method of claim 2, wherein the quantized learning equation is a learning equation based on a binary number system, as defined in Equation (35) below:
wₜ₊₁^{Q}=wₜ^{Q}−2^{-(n-k)}∇ƒ^{Q}(wₜ), n,k∈Z⁺, n>k (35)

6. The machine-learning method of claim 2, wherein the quantized learning equation is a probability differential learning equation defined in Equation (36) below:
dWₛ=−λₜ∇ƒ(Wₛ)ds+\sqrt{2σ(s)}·d\vec{B}ₛ (36)

7. The machine-learning method of claim 2, wherein the quantization coefficient is defined using \vec{h}(t), which is a monotonically increasing function of time, as shown in Equation (37) below:
Qₚ=η·b^{h̅(t)}, such that h̅(t)↑∞ as t→∞ (37)

8. The machine-learning method of claim 7, wherein initially setting the monotonically increasing function of time is configured to set the monotonically increasing function so as to satisfy Equation (38) below:
$$\frac{C}{ln 2} \leq σ ( t ) {\vert}_{t = 0} = \frac{γ}{24} \cdot {( η \cdot {b}^{\overline{h} ( 0 )} )}^{- 1} \leq \frac{{C}_{1}}{ln 2} = T ( t ) \\ ⇒ {log}_{b} \frac{γ ln 2}{24 η} {C}_{1}^{- 1} \leq \overline{h} ( 0 ) \leq {log}_{b} \frac{γ ln 2}{24 η} {C}^{- 1} \qquad ( 38 )$$

9. The machine-learning method of claim 8, wherein, when determining whether the quantization coefficient satisfies the predetermined condition is performed, the predetermined condition is Equation (39) below:
$$σ ( t ) \geq \frac{C}{log ( t + 2 )} \qquad ( 39 )$$

10. The machine-learning method of claim 9, wherein, when newly setting the monotonically increasing function of time is performed, the monotonically increasing function of time is defined as Equation (40) below:
$$\overline{h} ( {t}_{1} ) = ⌊ {log}_{b} \frac{y ln 2}{24 η} {C}^{- 1} + 0.5 ⌋ \qquad ( 40 )$$

11. A machine-learning apparatus based on monotonically increasing quantization resolution, comprising:
memory in which at least one program is recorded; and
a processor for executing the program,
wherein:
a quantization coefficient is defined as a monotonically increasing function of time, and
the program performs
initially setting the monotonically increasing function of time;
performing machine learning based on a quantized learning equation using the quantization coefficient defined by the monotonically increasing function of time;
determining whether the quantization coefficient satisfies a predetermined condition after increasing the time;
newly setting the monotonically increasing function of time when the quantization coefficient satisfies the predetermined condition; and
updating the quantization coefficient based on the newly set monotonically increasing function of time, and
performing the machine learning, determining whether the quantization coefficient satisfies the predetermined condition, newly setting the monotonically increasing function of time, and updating the quantization coefficient are repeatedly performed.

12. The machine-learning apparatus of claim 11, wherein the quantization coefficient is defined as a function varying over time as shown in Equation (41) below:
$$σ ( t ) = \frac{γ}{24} \cdot {Q}_{p}^{- 2} ( t ) , γ ∈ R \qquad ( 41 )$$

13. The machine-learning apparatus of claim 12, wherein is defined as shown in Equation (42) below:
Qₚ=η·bⁿ η∈Z⁺, η<b (42)
where a base b is b∈Z⁺, b≥2.

14. The machine-learning apparatus of claim 12, wherein the quantized learning equation is a learning equation for acquiring quantized weight vectors for all times, as defined in Equation (43) below:
$$\begin{matrix}{w}_{t + 1}^{Q} = {w}_{t}^{Q} - \frac{{α}_{t}}{{Q}_{p}^{2}} \cdot {Q}_{p} ∇ f ( {w}_{t} ) + {\vec{ɛ}}_{t} {Q}_{p}^{- 1} \\ = {w}_{t}^{Q} - \frac{{α}_{t}}{{Q}_{p}} \cdot \frac{1}{{Q}_{p}} [ {Q}_{p} ∇ f ( {w}_{t} ) ] ∵ {α}_{t} ∈ Q ( 0 , {Q}_{p} ) \\ = {w}_{t}^{Q} - \frac{{α}_{t}}{{Q}_{p}} ∇ {f}^{Q} ( {w}_{t} )\end{matrix} \qquad ( 43 )$$

15. The machine-learning apparatus of claim 12, wherein the quantized learning equation is a learning equation based on a binary number system, as defined in Equation (44) below:
wₜ₊₁^{Q}=wₜ^{Q}−2^{-(n-k)}∇ƒ^{Q}(wₜ), n,k∈Z⁺, n>k (44)

16. The machine-learning apparatus of claim 12, wherein the quantized learning equation is a probability differential learning equation defined in Equation (45) below:
dWₛ=−λₜ∇ƒ(Wₛ)ds+\sqrt{2σ(s)}·d\vec{B}ₛ (45)

17. The machine-learning apparatus of claim 12, wherein the quantization coefficient is defined using h̅(t), which is a monotonically increasing function of time, as shown in Equation (46) below:
Qₚ(r)=η·b^{h̅(t)}, such that h̅(t)↑∞ as t→∞ (46)

18. The machine-learning apparatus of claim 17, wherein initially setting the monotonically increasing function of time is configured to set the monotonically increasing function so as to satisfy Equation (47) below:
$$\frac{C}{ln 2} \leq σ ( t ) {\vert}_{t = 0} = \frac{γ}{24} \cdot {( η \cdot {b}^{\overline{h} ( 0 )} )}^{- 1} \leq \frac{{C}_{1}}{ln 2} = T ( t ) \\ ⇒ {log}_{b} \frac{γ ln 2}{24 η} {C}_{1}^{- 1} \leq \overline{h} ( 0 ) \leq {log}_{b} \frac{γ ln 2}{24 η} {C}^{- 1} \qquad ( 47 )$$

19. The machine-learning apparatus of claim 18, wherein, when determining whether the quantization coefficient satisfies the predetermined condition is performed, the predetermined condition is Equation (48) below:
$$σ ( t ) \geq \frac{C}{log ( t + 2 )} \qquad ( 48 )$$

20. The machine-learning apparatus of claim 19, wherein, when newly setting the monotonically increasing function of time is performed, the monotonically increasing function of time is defined as Equation (49) below:
$$\overline{h} ( {t}_{1} ) = ⌊ {log}_{b} \frac{y ln 2}{24 η} {C}^{- 1} + 0.5 ⌋ \qquad ( 49 )$$
